(19) United States
(12) Patent Application Publication
(10) Pub. No.: US 2011/0011198 A1
(43) Pub. Date: Jan. 20, 2011

(54) Brake Level for a Bicycle

(76) Inventor: Chia-Wei LIAO, Taichung County (TW)

Correspondence Address: Dr. BANGER SHIA;Patent Office of Bang Shia, 102 Lindencrest Ct., Sugar Land, TX, 77479-5201, US

(21) Appl. No.: 12/505,502

(22) Filed: Jul. 19, 2009

(51) Int. Cl. F16C 1/28

(52) U.S. Cl. 74/502.3

(57) ABSTRACT

A brake level for a bicycle is assembled and disassembled by a locking method. After assembly of the brake level, a brake cable can be assembled to the brake level just by means of a single through hole. By such arrangements, the assembling cost of the brake level can be reduced, and the brake level can be assembled and disassembled repeatedly.

### BACKGROUND OF THE INVENTION

1. Field of the Invention

The present invention relates to a brake level; and more particularly to a brake level for a bicycle.

2. Description of the Prior Art

Referring to FIG. 1, a bicycle 11 is normally equipped with a brake level 13 on a handlebar 12 thereof, and the brake level 13 is pressed to pull a brake cable 14 to control the braking of the bicycle during riding process. For example, referring to FIG. 2, a brake level for a bicycle disclosed in Taiwan Patent No. 088109413 comprises a level body 15 having an open end, and the open end of the level body 15 includes two oppositely arranged fins 151. The fins 151 include a first pair of opposite through holes 152 and a second pair of opposite through holes 153. As shown in FIG. 1, the first pair of opposite through holes 152 is pivotally coupled to the handlebar 12 of the bicycle 11 by a connecting shaft (not shown), and the second pair of opposite through holes 153 is assembled with a shaft 16 and a bushing 17 in such a manner that the shaft 16 and the bushing 17 can be positioned at the open end of the level body 15. The brake cable 14 are inserted into the shaft 16 and the bushing 17 and positioned therein. However, although the conventional brake level 13 of the bicycle 11 can control the braking of the bicycle 11, the brake level 13 of the bicycle suffers from many defects in terms of assembly, which are required to be improved immediately:

1. As shown in FIG. 3, the shaft 16 and the bushing 17 can be positioned between the two fins 151 of the level body 15 only when they are riveted together, further, the shaft 16 and the bushing 17 must be pre-assembled between the two fins 151 first and then they can be riveted together, and it is too difficult to rivet the shaft 16 and the bushing 17 together within the narrow space between the two fins 151 of the level body 15, hence, the assembling cost is increased.

2. The shaft 16 and the bushing 17 are positioned between the two fins 151 of the level body 15 by riveting, so the shaft 16 and the bushing 17 cannot be disassembled and assembled repeatedly after being riveted, once the shaft 16 and the bushing 17 are disassembled, they must be damaged and cannot be assembled again, therefore, as for the user with special needs, the structure design of this brake level is poor.

3. In order to enable the head portion of the brake cable 14 to be inserted into and positioned in the shaft 16 and the bushing 17, the transversal hole 161 of the shaft 16 must be coaxially aligned with the through hole 171 of the bushing during assembly, so the assembling steps of the brake level are increased, thus enhancing the assembling cost.

The present invention has arisen to mitigate and/or obviate the afore-described disadvantages.

### SUMMARY OF THE INVENTION

The primary objective of the present invention is to provide a brake level for a bicycle which can reduce the assembling cost.

The secondary objective of the present invention is to provide a brake level for a bicycle the respective elements of which can be assembled and disassembled repeatedly.

Hence, in order to achieve the above objectives, a brake level for a bicycle in accordance with the present invention comprises a level body, a shaft, an annular member and a connecting member. The level body includes a first fin and a second fin that are oppositely arranged at one end thereof, each of the first and the second fins includes an inner surface, an outer surface opposite the inner surface thereof, and a through hole penetrating the inner and the outer surfaces thereof. The shaft includes a first end surface and a second end surface that are oppositely arranged, and an outer peripheral surface between the first and the second end surfaces. The first end surface is provided with a protruding portion, and the second end surface is defined with a recessed connecting portion. The outer peripheral surface includes a through hole for insertion of a brake cable. The protruding portion is pivoted into the through hole of the first fin, and the first end surface abuts against the inner surface of the first fin. Between the second end surface and the inner surface of the second fin is defined a clearance. The annular member is disposed in the clearance and abuts against both the inner surface of the second fin and the second end surface of the shaft. The connecting member is inserted into the through hole of the second fin and the annular member and assembled in the connecting portion of the shaft.

### BRIEF DESCRIPTION OF THE DRAWINGS

FIG. 1 is a perspective view showing a brake level is disposed on a handlebar of a bicycle;

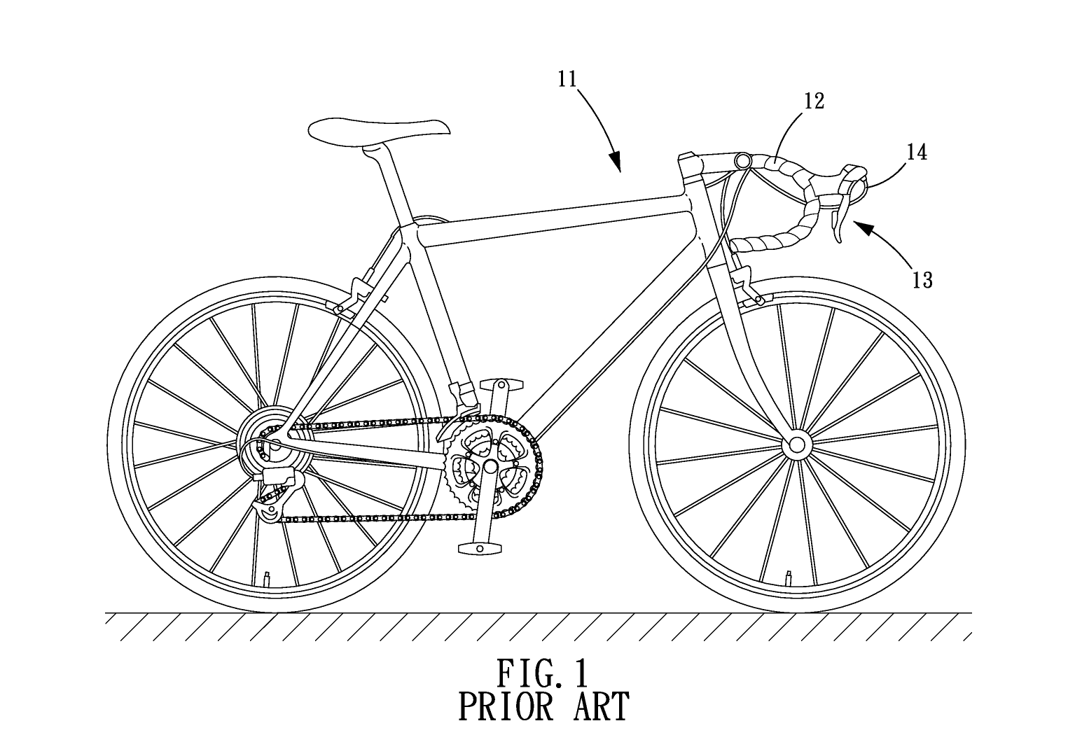

FIG. 2 is a perspective exploded view of a bicycle brake level disclosed in Taiwan Patent No. 088109413;

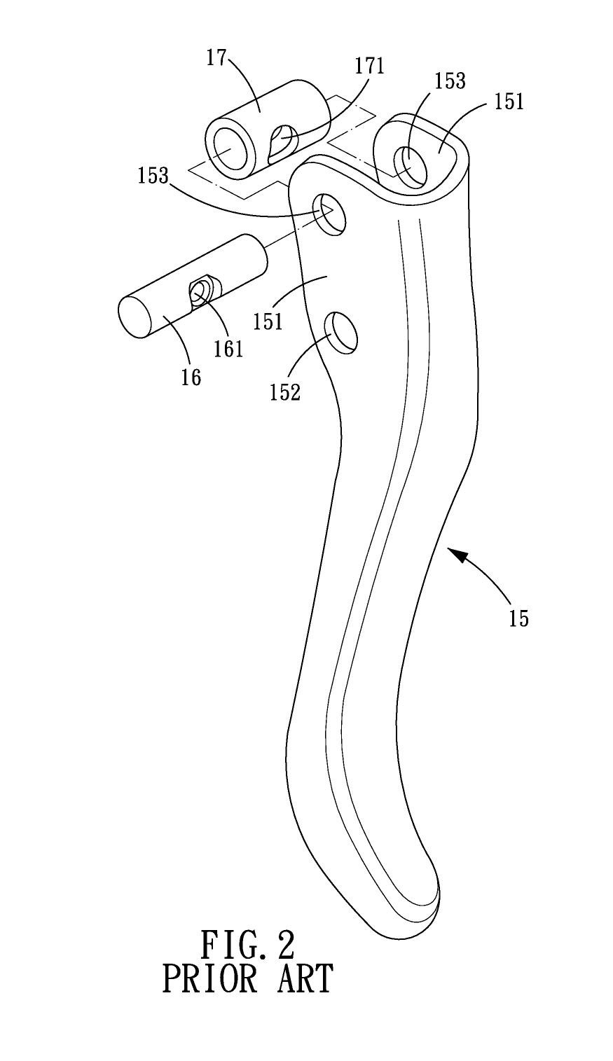

FIG. 3 is a partial cross sectional view of FIG. 2;

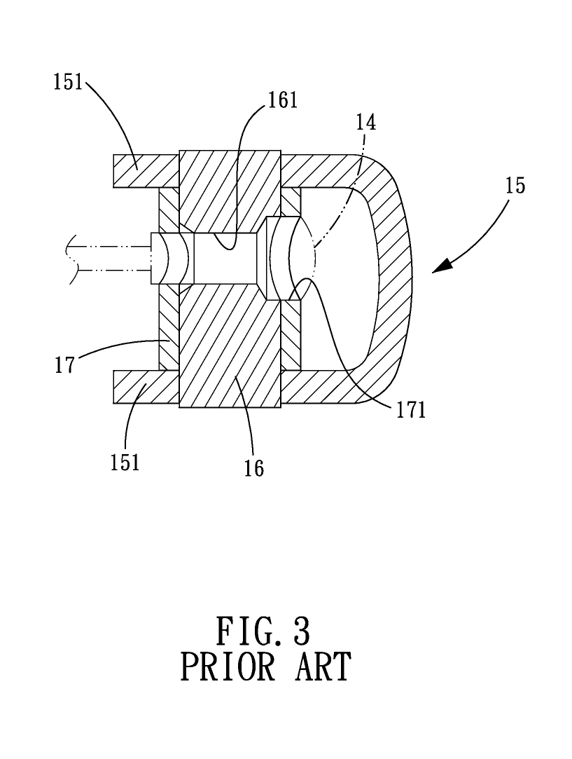

FIG. 4 is a perspective exploded view of a brake level for a bicycle in accordance with the present invention;

FIG. 5 is a perspective assembly view of the brake level for a bicycle in accordance with the present invention;

FIG. 6 is a partial cross sectional view of the brake level for a bicycle in accordance with the present invention; and

FIG. 7 is an assembly view of the brake level for a bicycle in accordance with the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

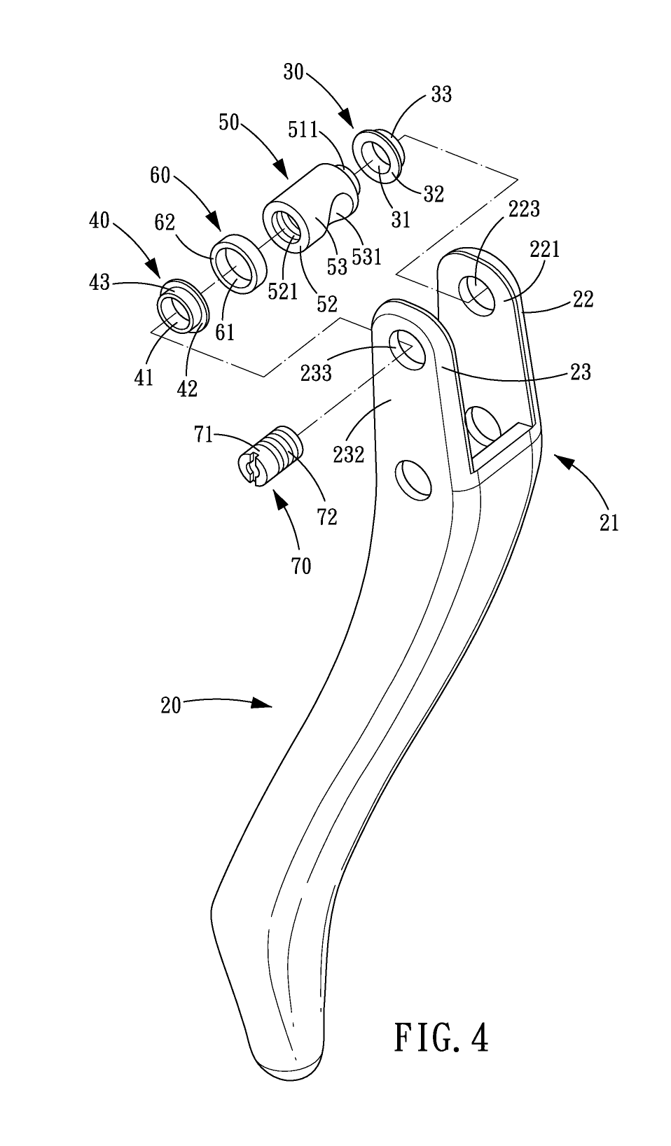

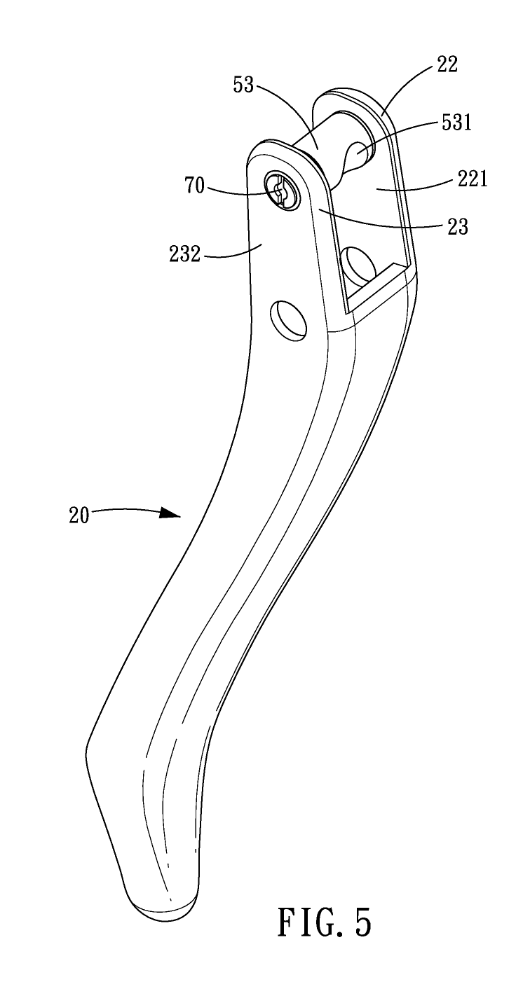

Referring to FIGS. 4-6, a brake level for a bicycle in accordance with a preferred embodiment of the present invention comprises a level body 20, a first bushing 30, a second bushing 40, a shaft 50, an annular member 60 and a connecting member 70.

The level body 20 includes an open end 21. The open end 21 includes a first fin 22 and a second fin 23 that are oppositely arranged. Each of the first fin 22 and the second fin 23 includes an inner surface 221, 231, an outer surface 222, 232 opposite to the inner surface 221, 231 thereof, 232 and a through hole 223, 233. The two inner surfaces 221, 231 of the first and the second fins 22, 23 are arranged in a face-to-face manner. The through holes 223, 233 penetrate the inner surfaces 221, 231 and the outer surfaces 222, 232, respectively.

The first bushing 30 is annular and includes an annular hole 31, an annular portion 32 and an annular flange 33 extending from a side surface of the annular portion 32. The outer diameter of the annular flange 33 is smaller than that of the annular portion 32. The annular flange 33 of the first bushing 30 is disposed in the through hole 223 of the first fin 22, and the annular portion 32 abuts against the inner surface 221 of the first fin 22. It is to be noted that, the diameter of the through hole 223 of the first fin 22 is bigger than the outer diameter of the annular flange 33 but smaller than the outer diameter of the annular portion 32, so that the annular flange 33 can be disposed in the through hole 223 of the first fin 22, and the annular portion 32 can abut against an outer periphery of the through hole 223.

The second bushing 40 is the same as the first bushing 30 in structure. The second bushing 40 is also annular and includes an annular hole 41, an annular portion 42 and an annular flange 43 extending from a side surface of the annular portion 42. The outer diameter of the annular flange 43 is smaller than that of the annular portion 42. The annular flange 43 of the second bushing 40 is disposed in the through hole 233 of the second fin 23, and the annular portion 42 abuts the inner surface 231 of the second fin 23. It is to be noted that, the diameter of the through hole 233 of the second fin 23 is bigger than the outer diameter of the annular flange 43 but smaller than the outer diameter of the annular portion 42, so that the annular flange 43 can be disposed in the through hole 233 of the second fin 23, and the annular portion 42 can abut against an outer periphery of the through hole 233 of the second fin 23.

The shaft 50 is cylinder-shaped and includes a first end surface 51, a second end surface 52 and an outer peripheral surface 53. The first end surface 51 and the second end surface 52 are oppositely arranged, and the outer peripheral surface 53 is located between the first end surface 51 and the second end surface 52. The first end surface 51 is provided with a protruding portion 511 along the axis of the shaft 50. The second end surface 52 is defined with a recessed connecting portion 521 extending along the axis of the shaft 50. The connecting portion 521 can be a threaded groove. The outer peripheral surface 53 includes a through hole 531 for insertion of the brake cable 81. The protruding portion 511 is pivoted into the annular hole 31 of the first bushing 30 and correspondingly located in the through hole 223 of the first fin 22, and the first end surface 51 of the shaft 50 abuts against the annular portion 32 of the first bushing 30. Between the second end surface 52 of the shaft 50 and the annular portion 42 of the second bushing 40 is defined a clearance A.

The annular member 60 includes an annular hole 61 and two annular end surfaces 62 on both ends thereof. The annular member 60 is disposed in the clearance A in such a manner that the two annular end surfaces 62 of the annular member 60 abut against the second end surface 52 of the shaft 50 and the annular portion 42 of the second bushing 40, respectively. It is to be noted that the diameter of the annular hole 61 of the annular member 60 is bigger than the diameter of the connecting portion 521 of the shaft 50, so that the annular member 60 won't cover the connecting portion 521 after assembly.

The connecting member 70 includes a head portion 71 and a combining portion 72. The combining portion 72 can be a threaded portion. The connecting member 70 is inserted into the annular hole 41 of the second bushing 40, the annular hole 61 of the annular member 60 and assembled into the connecting portion 521 through the through hole 233 of the second fin 23, that is to say the head portion 71 is inserted into the through hole 233 of the second fin 23, and the combining portion 72 is inserted into the annular member 60 and assembled into the connecting portion 521 of the shaft 50.

The aforementioned is the summary of the positional and structural relationship of the respective components of the preferred embodiment in accordance with the present invention.

With the structure of the above embodiment, the present invention has the following advantages:

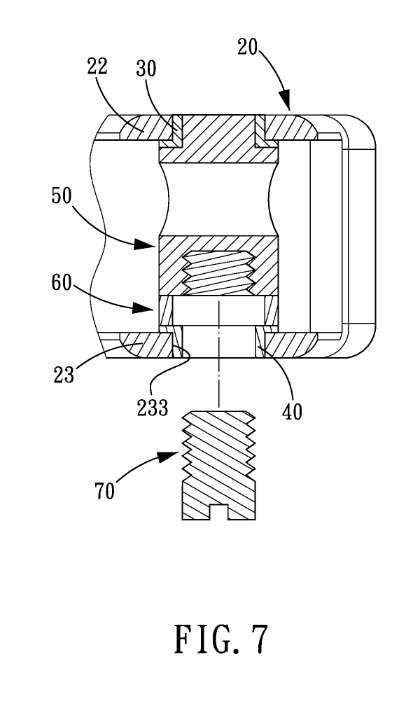

1. As shown in FIG. 7, since the assembling method of the present invention is to dispose the first, the second bushings 30, 40, the shaft 50 and the annular member 60 between the first and the second fins 22, 23 of the level body 20 first, and then insert the connecting member 70 from the through hole 233 of the second fin 23 to lock it into the connecting portion 521 through the annular hole 41 of the second bushing 40 and the annular hole 61 of the annular member 60 to finish the assembly of the brake level, the present invention doesn't need any special assembling method but finishes the assembly of the brake level just by directly performing a locking operation outside the level body 20, thereby, the present invention can assuredly reduce the assembling cost of the brake level.

2. Since the present invention can utilize the locking method to finish the assembly of the brake level, the respective elements of the brake level can also be disassembled by the same locking method, further, the assembly and the disassembly of the brake level will not damage the structures of the respective elements, thereby, the present invention can assuredly achieve the objective that the brake level can be disassembled and assembled repeatedly to meet the actual needs.

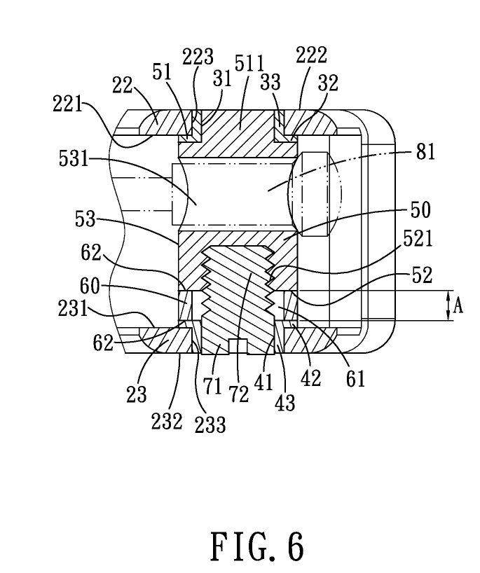

3. Referring to FIG. 6, after the assembly of the brake level is finished, the single through hole 531 is provided for insertion and positioning of the brake cable 81, so, as compared with the conventional brake level, the present invention doesn't need the assembly step of coaxially aligning the through holes for insertion and positioning of the brake cable with each other, thereby, the present invention can assuredly achieve the objective of reducing the assembling cost of the brake level.

While we have shown and described various embodiments in accordance with the present invention, it is clear to those skilled in the art that further embodiments may be made without departing from the scope of the present invention.

What is claimed is:

1. A brake level for a bicycle comprising:
a level body including a first fin and a second fin that are oppositely arranged at one end thereof, each of the first and the second fins including an inner surface, an outer surface opposite the inner surface thereof, and a through hole penetrating the inner and the outer surfaces;
a shaft including a first end surface and a second end surface that are oppositely arranged, and an outer peripheral surface between the first and the second end surfaces, the first end surface being provided with a protruding portion, the second end surface being defined with a recessed connecting portion, the outer peripheral surface including a through hole for insertion of a brake cable, the protruding portion being pivoted into the through hole of the first fin, the first end surface abutting against the inner surface of the first fin, between the second end surface and the inner surface of the second fin being defined a clearance;
an annular member being disposed in the clearance and abutting against both the inner surface of the second fin and the second end surface of the shaft; and
a connecting member being inserted into the through hole of the second fin and the annular member and assembled in the connecting portion of the shaft.

2. The brake level for a bicycle as claimed in claim 1, wherein a first bushing is disposed between the first end surface of the shaft and the inner surface of the first fin, and a second bushing is disposed between the annular member and the inner surface of the second fin.

3. The brake level for a bicycle as claimed in claim 2, wherein each of the first and the second bushings includes an annular portion and an annular flange protruding from a side surface of the annular portion thereof, an outer diameter of the respective annular flanges is smaller than that of the respective annular portions, the annular flanges of the first bushing and the second bushing are disposed in the respective through holes of the first and the second fins, and the two annular portions abut against the respective inner surfaces of the first and the second fins, the protruding portion of the shaft is pivoted into the first bushing, the first end surface of the shaft abuts against the annular portion of the first bushing, the annular member abuts against both the second end surface of the shaft and the annular portion of the second bushing.

4. The brake level for a bicycle as claimed in claim 1, wherein the connecting member includes a head portion and a combining portion, the head portion is inserted into the through hole of the second fin, and the combining portion is inserted into the annular member and assembled with the connecting portion.

5. The brake level for a bicycle as claimed in claim 4, wherein the combining portion is a threaded portion, and the connecting portion is a threaded groove.
